(19) United States
(12) Patent Application Publication
(10) Pub. No.: US 2026/0261747 A1
(43) Pub. Date: Sep. 3, 2026

(54) SYSTEM AND METHOD FOR AUTOMATED SELECTION FROM MULTIPLE SIMULTANEOUS VIDEO STREAMS

(71) Applicant: Vizi Inc.

(72) Inventors: Adam James Silver, Baiona (ES); William Bradshaw Pillow, Zionsville, IN (US)

(73) Assignee: Vizi Inc., (US)

(21) Appl. No.: 19/553,439

(22) Filed: Mar. 2, 2026

Related U.S. Application Data
(60) Provisional application No. 63/766,240, filed on Mar. 3, 2025.

(51) Int. Cl. H04N 21/8541; H04N 21/218; H04N 21/466

(52) U.S. Cl. CPC H04N 21/8541; H04N 21/21805; H04N 21/4665

(57) ABSTRACT

A system and method for automated arbitration between multiple simultaneous video streams capturing a common real-world occurrence are provided. The system determines a temporal narrative state of the occurrence and computes, for each candidate video stream, a marginal contribution value relative to a currently selected output stream based on contextual divergence. A redundancy penalty is determined based on contextual similarity. A composite arbitration score is generated using at least the marginal contribution value and the redundancy penalty, and a competitive comparison of composite arbitration scores is performed to select a candidate stream for output. In certain embodiments, a predicted transition window based on the projected change in the temporal narrative state controls the timing of stream transitions

### REFERENCE TO RELATED APPLICATIONS

This application claims the benefit of U.S. Provisional Patent Application No. 63/766,240 titled “AI VIDEO CLOUD SERVICE AND MULTI-CAMERA SYSTEM”, filed on 03/03/2025, which is incorporated by reference herein in its entirety.

### TECHNICAL FIELD

The present disclosure relates generally to systems and methods for automated video production. More particularly, the disclosure relates to systems and methods for dynamic arbitration between multiple simultaneous video streams capturing a common real-world occurrence, wherein selection of an output stream is governed by temporal narrative modeling and inter-stream contextual comparison.

### BACKGROUND

Modern capture environments frequently involve multiple camera devices simultaneously recording the same real-world occurrence from different viewpoints. Automated systems have been developed to select one stream from among multiple candidates. Many such systems evaluate each stream independently based on quality metrics, motion intensity, event detection signals, or learned scoring models, and select a stream having a highest evaluated score.

However, independent ranking approaches do not account for contextual redundancy between streams. Further, such approaches typically operate in a reactive manner based on present characteristics of streams without modelling the temporal progression of the occurrence being captured.

When multiple streams exhibit similar contextual content, independent scoring may result in repetitive or redundant output selection. Additionally, selection based solely on instantaneous metrics may fail to preserve narrative continuity during evolving event phases.

Accordingly, there is a need for improved methods and systems for facilitating automated selection of an output video stream from multiple simultaneous video streams capturing a common real-world occurrence that can overcome one or more of the preceding problems.

### SUMMARY

To address limitations associated with the independent ranking of multiple video streams, the present disclosure provides a system and method for automated inter-stream arbitration based on temporal narrative modeling and contextual comparison between candidate streams.

In one aspect, a system is disclosed comprising a plurality of candidate video streams capturing a common real-world occurrence and a computing platform configured to determine a temporal narrative state of the occurrence. The computing platform computes, for each candidate stream, a marginal contribution value relative to a currently selected output stream and determines a redundancy penalty based on contextual similarity between streams. A composite arbitration score is generated using at least the marginal contribution value and the redundancy penalty, and selection of an output stream is performed through competitive comparison of the composite arbitration scores.

In another aspect, the system models the progression of the real-world occurrence through predefined narrative phases and dynamically adjusts arbitration logic based on the determined phase. Selection of a candidate stream is therefore governed not solely by independent evaluation of stream characteristics, but by incremental contextual contribution and suppression of redundant viewpoints relative to the current output stream.

In certain embodiments, the system further determines a predicted transition window based on projected changes in the temporal narrative state and performs controlled transitions between streams.

By performing inter-stream arbitration using narrative state modelling and contextual redundancy suppression, the disclosed system generates an output video stream that maintains narrative continuity while avoiding repetitive or contextually duplicative viewpoints.

### BRIEF DESCRIPTION OF THE DRAWINGS

The detailed description of the present invention is described with reference to the accompanying figures. The same reference numbers are used throughout the drawings to reference like features and components.

FIG. 1 illustrates a system for dynamic inter-stream arbitration between a plurality of candidate video streams, in accordance with an embodiment of the present disclosure.

FIG. 2 illustrates a temporal narrative state model comprising predefined event phases and transition logic, in accordance with an embodiment of the present disclosure.

FIG. 3 illustrates computation of a marginal contribution value and a redundancy penalty for a candidate video stream relative to a currently selected output stream, in accordance with an embodiment of the present disclosure.

FIG. 4 illustrates generation of a composite arbitration score based on marginal contribution, redundancy penalty, and temporal weighting, in accordance with an embodiment of the present disclosure.

FIG. 5 illustrates determination of a predicted transition window based on projected change in a temporal narrative state, in accordance with an embodiment of the present disclosure.

FIG. 6 illustrates competitive comparison of composite arbitration scores for selection of a candidate video stream, in accordance with an embodiment of the present disclosure.

FIG. 7 illustrates a flowchart of a method for automated arbitration between multiple simultaneous video streams capturing a common real-world occurrence, in accordance with some embodiments.

FIG. 8 illustrates a block diagram of a system for automated selection of a video stream from a plurality of simultaneous video streams capturing a common real-world occurrence, in accordance with some embodiments.

### DETAILED DESCRIPTION

The following detailed description is provided to illustrate representative embodiments of the present disclosure and is not intended to limit the scope of the invention, which is defined by the appended claims. The embodiments described herein may be implemented in various forms, and the disclosure is not limited to the specific systems, methods, or configurations described.

The embodiments described in this application relate to automated arbitration between multiple simultaneous video streams capturing a common real-world occurrence. More particularly, the disclosure relates to systems and methods for selecting an output video stream based on temporal narrative modelling and contextual comparison between candidate video streams.

Unless expressly stated otherwise, the features described in connection with one embodiment may be combined with features described in connection with other embodiments. The absence of a feature in a described embodiment does not imply that such feature is excluded from other embodiments.

As used herein, the singular forms “a,” “an,” and “the” include plural referents unless the context clearly indicates otherwise. The terms “comprising,” “including,” and “having” are used in an open-ended sense and do not exclude additional elements or steps not expressly recited.

The term “candidate video stream” refers to a sequence of visual data captured over time by a camera device and representing a viewpoint of a common real-world occurrence. A candidate video stream may be continuous or segmented and may be encoded in any suitable format. The term “currently selected output stream” refers to a candidate video stream that is presently designated for generation of an output video stream. The term “output video stream” refers to a directed video stream generated by the system based on arbitration decisions. The term “temporal narrative state” refers to a representation of an evolving contextual phase of the real-world occurrence over time. A temporal narrative state may correspond to predefined event phases and may transition between phases during operation of the system. The term “contextual indicator” refers to information derived from a video stream that represents activity, subject presence, motion characteristics, spatial composition, or other event-related characteristics observable in visual data. The term “marginal contribution value” refers to a computed value representing incremental contextual relevance of a candidate video stream relative to the currently selected output stream. The term “redundancy penalty” refers to a computed suppression factor applied when contextual similarity between a candidate video stream and the currently selected output stream exceeds a predefined threshold. The term “composite arbitration score” refers to a computed value derived from at least the marginal contribution value and the redundancy penalty and used for competitive comparison between candidate video streams. The term “transition window” refers to a time interval during which the transition between video streams is determined to be appropriate based on projected change in temporal narrative state. Unless expressly stated otherwise, operations described herein may be performed in real time during capture of the real-world occurrence or after capture has completed.

The computing system described herein may be implemented using one or more processors executing instructions stored on one or more non-transitory computer-readable media. Unless explicitly stated otherwise, the order of operations described herein is not intended to require performance in the recited order, and operations may be combined, omitted, or reordered consistent with the appended claims.

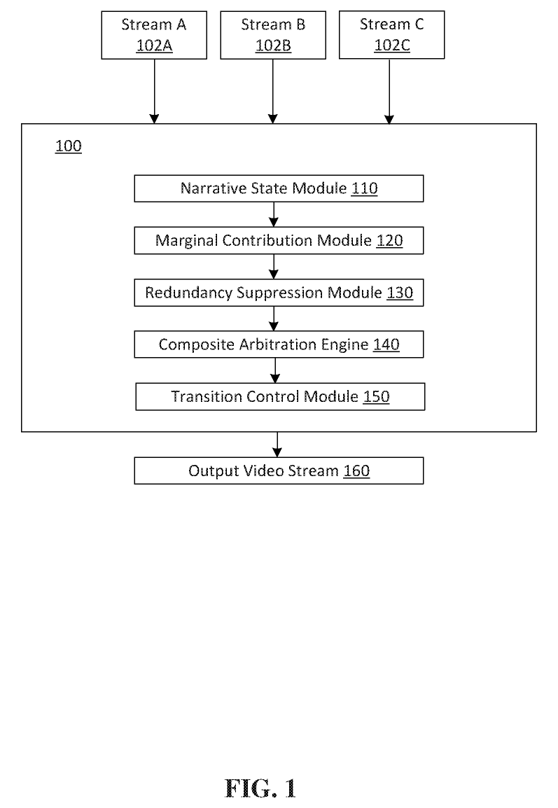

Referring to FIG. 1, a system 100 for dynamic inter-stream arbitration is illustrated. The system 100 is configured to receive a plurality of candidate video streams 102A, 102B, and 102C capturing a common real-world occurrence from different viewpoints. The plurality of candidate video streams may originate from independent camera devices, fixed-position cameras, mobile devices, wearable cameras, vehicle-mounted cameras, or any other capture devices capable of generating video streams. Further, the system 100 may be an inter-stream arbitration system.

Each candidate video stream 102A – 102C is received by a computing platform forming part of system 100. The computing platform comprises one or more processors and one or more non-transitory computer-readable memories storing instructions that, when executed, cause the computing platform to perform the arbitration operations described herein.

The system 100 comprises: a narrative state determination module 110 (i.e., narrative state module); a marginal contribution computation module 120 (i.e., marginal contribution module); a redundancy suppression module 130; a composite arbitration engine 140; and a transition control module 150.

The system 100 generates an output video stream 160 based on arbitration decisions determined by the composite arbitration engine 140. A defining architectural aspect of system 100 is that editorial selection is not performed independently per stream. Rather, selection is performed through inter-stream comparison relative to: (i) an evolving temporal narrative state; and (ii) a currently selected output stream.

The candidate video streams 102A – 102C are not required to be synchronized with one another. Streams may differ in resolution, frame rate, bitrate, latency, viewpoint, framing, and activity level. The system 100 does not require a uniform capture configuration among camera devices.

In some embodiments, the candidate video streams are received in real time during capture of the real-world occurrence. In other embodiments, the candidate video streams may be previously recorded streams provided for post-capture arbitration.

The narrative state determination module 110 is configured to determine a temporal narrative state of the real-world occurrence based on contextual indicators derived from the candidate video streams.

The marginal contribution computation module 120 is configured to compute, for each candidate video stream, a marginal contribution value relative to a currently selected output stream.

The redundancy suppression module 130 is configured to determine a redundancy penalty when contextual similarity between streams exceeds a predefined threshold.

The composite arbitration engine 140 generates a composite arbitration score for each candidate video stream based on at least the marginal contribution value and the redundancy penalty.

The transition control module 150 executes a transition from the currently selected output stream to a selected candidate video stream based on competitive comparison of composite arbitration scores.

Importantly, camera devices providing candidate video streams do not determine stream selection, transition timing, or presentation order. Arbitration logic is centralized within the computing platform of system 100.

In some embodiments, the computing platform may operate on a single device. In other embodiments, the computing platform may be distributed across multiple cooperating devices, provided that arbitration decisions are determined within the system 100 rather than at the capture devices.

The architecture illustrated in FIG. 1 establishes separation between capture of video streams, inter-stream arbitration, and output generation. This separation enables scalable arbitration across multiple candidate streams without requiring modification of camera devices.

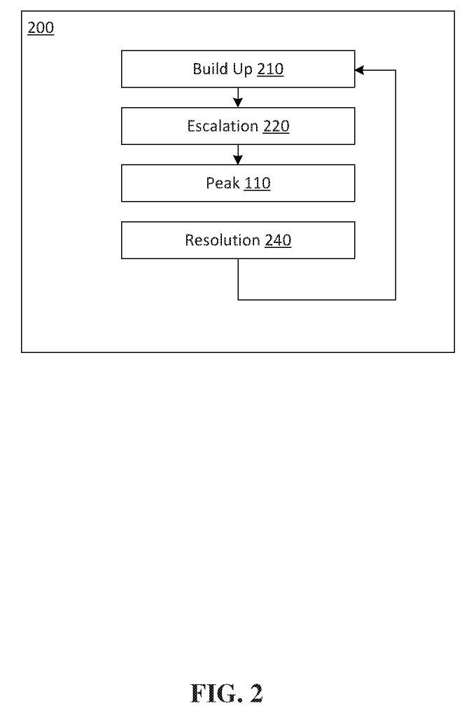

Referring to FIG. 2, a temporal narrative state model 200 is illustrated. The temporal narrative state model 200 represents an evolving contextual phase of the real-world occurrence captured by the plurality of candidate video streams. In the illustrated embodiment, the model 200 (i.e., temporal narrative state model) comprises predefined event phases including: a build-up state 210; an escalation state 220; a peak state 230; and a resolution state 240.

Transition logic governs movement between event phases. The temporal narrative state is determined by the narrative state determination module 110 (FIG. 1) based on contextual indicators derived from the candidate video streams.

Contextual indicators may include, without limitation: motion intensity levels; detected subject movement; rate of change in visual activity; spatial convergence of subjects; relative proximity of key objects; detected event-specific patterns; or other observable characteristics derivable from visual data.

The temporal narrative state is not determined based solely on any single candidate video stream. In some embodiments, contextual indicators from multiple candidate video streams are aggregated prior to the determination of the temporal narrative state.

The narrative state may be maintained as a state variable stored in memory and updated dynamically during operation of the system. Transition logic may define: threshold-based transitions; rule-based transitions; state transition matrices; or probabilistic transitions between predefined phases.

In some embodiments, the transition from build-up state 210 to escalation state 220 may occur when contextual indicators exceed a predefined activity threshold. Transition from escalation state 220 to peak state 230 may occur upon detection of a high-intensity contextual event. Transition from peak state 230 to resolution state 240 may occur when contextual intensity decreases below a predefined threshold.

The narrative state model 200 operates independently of stream selection. That is, determination of the temporal narrative state precedes and informs inter-stream arbitration but does not itself perform stream selection.

In some embodiments, the temporal narrative state may be updated continuously as contextual indicators evolve over time. In other embodiments, updates may occur at discrete intervals. The system does not require that transitions occur in a strictly linear sequence. Alternative embodiments may permit direct transitions between non-adjacent states depending on contextual conditions.

The system 100 derives contextual indicators from candidate video streams 102A–102C (FIG. 1) to support the determination of temporal narrative state (FIG. 2) and to support subsequent inter-stream arbitration operations.

In some embodiments, contextual indicators are derived by processing video frames from each candidate video stream using one or more feature extraction techniques. Feature extraction may be performed on each frame, on groups of frames, or on time windows defined by a sampling interval. Contextual indicators may include, without limitation: Motion and activity indicators that may represent measurable activity within a video stream and may include: motion vector magnitude statistics; optical flow-based activity scores; inter-frame difference metrics; scene stability metrics (e.g., camera shake estimation); detected acceleration or deceleration of a subject region; and rate-of-change measures over time. Motion and activity indicators may be computed per frame and aggregated over time windows.

In some embodiments, the system detects the presence of one or more subjects and derives subject-centric indicators, including: detected subject count; subject bounding region information; subject position within a frame (e.g., center-weighted position measures); subject scale changes (e.g., zoom-in/zoom-out inference); subject visibility or occlusion measures; and subject continuity measures across frames. The term “subject” may refer to a person, object, vehicle, ball, or other entity relevant to the real-world occurrence.

Composition and framing indicators may represent visual framing suitability and may include: framing alignment of a subject region relative to a target framing profile; focus and sharpness measures; brightness, contrast, and exposure measures; horizon alignment measures; degree of cropping of a key subject; and image clutter measures. Composition indicators are not limited to aesthetic preferences and may be configured to represent framing relevancy for the real-world occurrence.

Event progression indicators may represent a temporal interpretation of evolving activity and may include: detected onset of an action pattern; detection of repeated action cycles; convergence/divergence of subjects in a scene; entry/exit events of a subject region; transitions between low activity and high activity intervals; and other temporal markers indicative of event phase changes. Event progression indicators may be used to support transitions between narrative states in the model 200 (FIG. 2).

In some embodiments, viewpoint indicators are derived to represent how a candidate stream covers the real-world occurrence, such as estimated camera orientation changes; inferred viewpoint shifts over time; relative coverage of a region of interest; degree of overlap between streams capturing similar subject regions; and indicators of unique scene content relative to other candidate streams. Viewpoint indicators may be used to quantify redundancy and incremental contribution.

In some embodiments, contextual indicators derived from a candidate stream are assembled into a contextual feature representation for the candidate stream. The contextual feature representation may be: a vector representation; a set of structured feature values; a time-series representation; or any other representation suitable for comparison across streams. Contextual feature representations may be maintained for each candidate stream and updated over time as additional frames are received.

In some embodiments, contextual indicators are normalized to enable comparison between streams having differing capture properties (e.g., resolution, frame rate, or exposure). Normalization may be performed per feature type or per stream.

In some embodiments, contextual indicators are derived using sliding windows or fixed windows. For example, a first set of indicators may be computed at a first sampling interval, and a second set of indicators may be computed at a different interval.

Different indicators may be derived at different frequencies. For example, motion indicators may be computed at a higher rate than composition indicators. The window size, sampling interval, and aggregation technique may be configured based on the real-world occurrence, computational constraints, or desired responsiveness.

The contextual feature derivation described herein is based on video stream data.

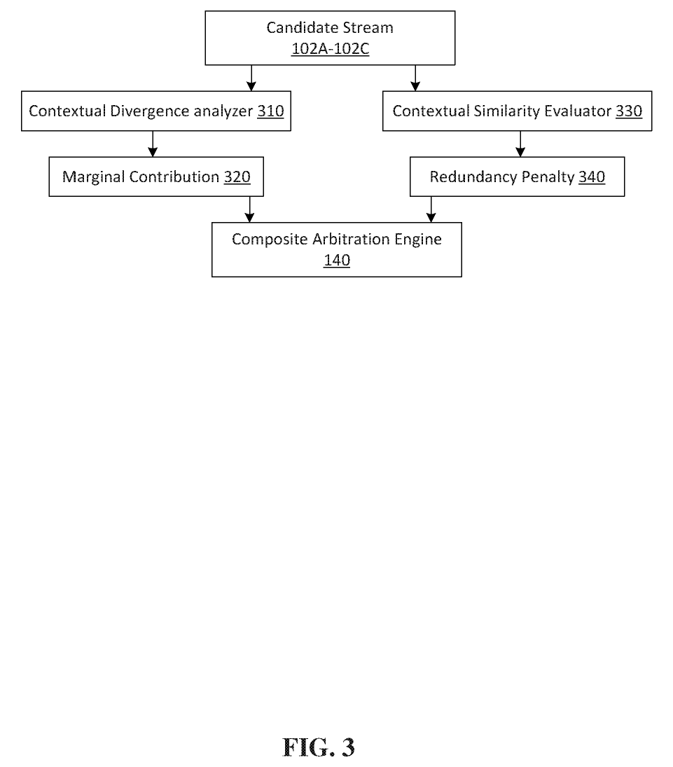

Referring to FIG. 3, marginal contribution computation module 120 determines a marginal contribution value 320 for a candidate video stream 302 relative to a currently selected output stream 304. Unlike independent ranking systems that evaluate each stream in isolation, the marginal contribution computation module 120 performs comparative evaluation between: a candidate video stream 302, and the currently selected output stream 304.

As illustrated in FIG. 3, contextual divergence analyzer 310 receives contextual feature representations corresponding to: candidate video stream 302; and currently selected output stream 304. The contextual divergence analyzer 310 computes a contextual divergence measure representing the difference between contextual indicators of the candidate stream and those of the currently selected stream.

Contextual divergence may be computed based on one or more of: differences in motion intensity; differences in subject position; differences in framing and composition; differences in scene coverage; differences in detected event progression indicators; or differences in viewpoint characteristics.

The divergence measure may represent: Euclidean distance between feature vectors; cosine dissimilarity; weighted feature difference; threshold-based feature deviation; or any other measurable contextual difference metric. The contextual divergence analyzer 310 generates a divergence output that is used to compute the marginal contribution value 320.

The marginal contribution value 320 represents the incremental contextual relevance of the candidate video stream relative to the currently selected output stream. In some embodiments, the marginal contribution value is positively correlated with contextual divergence. That is, greater contextual difference may correspond to greater marginal contribution, provided that the difference is contextually meaningful.

In certain embodiments, divergence measures may be weighted by narrative state (as determined in FIG. 2). For example, during escalation state 220, motion-related divergence may receive higher weight; during resolution state 240, composition-related divergence may receive higher weight. However, weighting mechanics are not required in all embodiments. The marginal contribution value 320 may be normalized across candidate streams to enable comparative evaluation.

The marginal contribution value is not an absolute quality score of a candidate stream. Instead, it represents incremental value relative to what is already being shown in the currently selected output stream 304.

Thus, even if a candidate stream exhibits high intrinsic activity or quality, its marginal contribution may be low if it does not materially differ from the currently selected stream. This relative evaluation prevents repetitive selection of similar viewpoints.

In some embodiments, marginal contribution values are updated continuously as contextual feature representations evolve over time.

The system may: recompute marginal contribution values at fixed intervals; recompute upon detection of contextual change; or recompute upon narrative state transition.

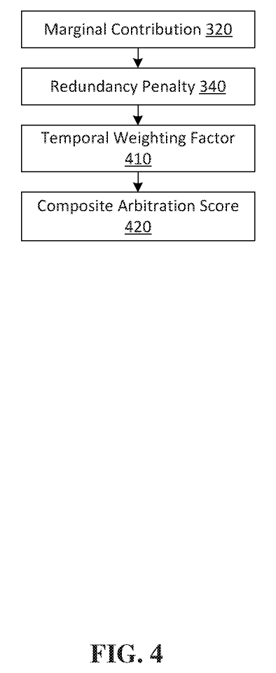

Marginal contribution values may therefore vary dynamically during generation of the output video stream 160 (FIG. 1). The marginal contribution computation module 120 performs computation independently for each candidate stream relative to the currently selected output stream. Thus, at a given time instance, a set of marginal contribution values may be generated corresponding to each candidate stream. These values are subsequently provided to the composite arbitration engine 140 (FIG. 1 and FIG. 4) for competitive comparison.

Referring again to FIG. 3, redundancy suppression module 130 determines a redundancy penalty 340 for a candidate video stream 302 relative to the currently selected output stream 304. Whereas the marginal contribution computation module 120 evaluates contextual divergence, the redundancy suppression module 130 evaluates contextual similarity.

As illustrated in FIG. 3, a contextual similarity evaluator 330 receives contextual feature representations corresponding to: candidate video stream 302; and currently selected output stream 304.

The contextual similarity evaluator 330 computes a contextual similarity measure representing overlap between contextual indicators of the candidate stream and those of the currently selected stream.

Contextual similarity may be determined based on one or more of: similarity in subject position within a frame; similarity in motion patterns; similarity in viewpoint orientation; similarity in detected event phase indicators; similarity in framing and scene composition; or similarity in scene coverage regions.

In some embodiments, similarity may be computed using: feature vector similarity metrics; overlap coefficients; structural similarity measures; or threshold-based comparison of feature differences. The contextual similarity evaluator 330 generates a similarity output used to determine the redundancy penalty 340.

The redundancy penalty 340 represents a suppression factor applied to a candidate video stream when contextual similarity to the currently selected output stream exceeds a predefined threshold.

In certain embodiments, if similarity is below a threshold, the redundancy penalty may be zero or minimal; if similarity exceeds a threshold, the redundancy penalty increases proportionally.

The redundancy penalty may be: linearly proportional to similarity; non-linearly scaled; or determined using threshold tiers.

The redundancy penalty 340 may reduce the likelihood that a candidate stream is selected when it does not materially alter the narrative perspective.

Importantly, redundancy is evaluated relative to the currently selected output stream 304 rather than relative to other candidate streams in isolation. Thus, a candidate stream may be considered redundant if it substantially reproduces the contextual content already being presented to a viewer through the output stream. This relative suppression mechanism distinguishes the system from approaches that independently rank streams without penalizing contextual duplication.

In some embodiments, the redundancy penalty may be influenced by the duration of continuous output of the currently selected stream. For example, if the currently selected stream has been active for a prolonged duration, similarity tolerance thresholds may be adjusted; redundancy penalty scaling may vary depending on temporal narrative state (FIG. 2). Such embodiments enable controlled persistence of a viewpoint without allowing indefinite repetition.

The redundancy suppression module 130 may compute redundancy penalties independently for each candidate stream relative to the currently selected output stream. Accordingly, a set of redundancy penalties may be generated corresponding to the plurality of candidate streams at a given time instance.

These penalties are subsequently provided to composite arbitration engine 140 (FIG. 4) for incorporation into composite arbitration scores.

Referring to FIG. 4, composite arbitration engine 140 generates a composite arbitration score 420 for each candidate video stream. The composite arbitration engine 140 receives as inputs: marginal contribution value 320 (from FIG. 3); redundancy penalty 340 (from FIG. 3); and temporal weighting factor 410.

The composite arbitration score 420 represents a structured evaluation of a candidate stream for selection as the output stream.

In some embodiments, the composite arbitration score is determined using a combination of: a contextual relevance component; a redundancy suppression component; and a narrative-phase weighting component.

In one illustrative embodiment: Composite Arbitration Score = Base Contextual Relevance − Redundancy Penalty + Temporal Weight.

The base contextual relevance may correspond to the marginal contribution value 320. The redundancy penalty 340 reduces the composite score when contextual similarity to the currently selected output stream is high. The temporal weighting factor 410 may depend on the temporal narrative state determined in FIG. 2. The present disclosure is not limited to any particular mathematical formulation. Composite score generation may use additive, multiplicative, weighted, threshold-based, or rule-based formulations.

The temporal weighting factor 410 adjusts arbitration behavior based on the narrative state. For example, during build-up state 210 (FIG. 2), stable framing may be preferred; during escalation state 220, dynamic divergence may receive higher weighting; during peak state 230, streams capturing high-intensity contextual indicators may receive additional weighting; during resolution state 240, composition stability may be emphasized. The temporal weighting factor may therefore dynamically modulate arbitration sensitivity to contextual divergence.

In some embodiments, temporal weighting may be implemented using predefined weights. In other embodiments, weighting may be adaptive.

Composite arbitration engine 140 generates a composite arbitration score 420 for each candidate video stream at a given time instance.

Accordingly, a set of composite arbitration scores may be generated corresponding to candidate streams 102A–102C (FIG. 1). These scores are not absolute quality measures. Rather, they represent structured competitive evaluations incorporating: incremental contextual contribution; suppression of redundancy; and narrative-phase influence.

Composite arbitration scores may be recomputed: continuously in real time; at fixed intervals; upon contextual feature updates; or upon transition of narrative state.

The system may maintain historical composite arbitration scores for smoothing or hysteresis purposes, preventing excessive switching between streams.

In some embodiments, selection thresholds may be applied to prevent switching unless a candidate stream’s composite arbitration score exceeds the currently selected stream’s score by a predefined margin.

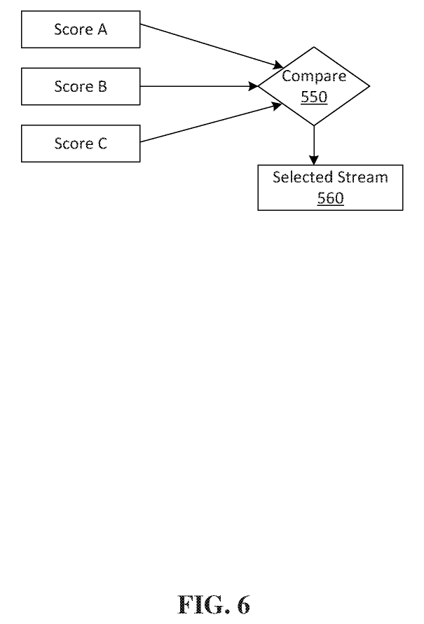

Referring to FIG. 6, a competitive comparison of composite arbitration scores is illustrated. Composite arbitration engine 140 (FIG. 4) generates a composite arbitration score for each candidate video stream. These scores are provided to the transition control module 150 (FIG. 1), which performs competitive comparison. In FIG. 6, composite scores corresponding to multiple candidate streams (e.g., Score A, Score B, Score C) are provided to a comparison operation 550.

The comparison operation 550 evaluates composite arbitration scores across candidate streams to determine a selected stream 560. In some embodiments, the candidate stream having the highest composite arbitration score is selected.

In other embodiments, selection may require that a candidate stream’s composite arbitration score exceeds the composite score of the currently selected output stream by a predefined threshold margin.

This margin-based comparison reduces excessive switching between streams and prevents oscillatory transitions when scores are similar.

The system may therefore apply: a minimum switching threshold; a hysteresis margin, or a persistence condition requiring a candidate stream to maintain a superior score for a minimum duration before transition.

Importantly, selection is not performed as an independent ranking of candidate streams in isolation. Rather, selection is performed relative to: the currently selected output stream; and composite arbitration scores incorporating redundancy suppression and marginal contribution. Thus, a candidate stream is selected only when it provides sufficient incremental contextual benefit relative to the currently selected stream.

Upon determination of selected stream 560, transition control module 150 (FIG. 1) initiates transition from the currently selected output stream to the selected candidate stream.

Transition may be executed using: immediate switching; buffered switching; crossfade; dissolve; cut; or other transition techniques. The type of transition may depend on narrative state (FIG. 2) or contextual conditions.

To further enhance stability, the system may incorporate: minimum display duration constraints for selected streams; cooldown intervals between transitions; smoothing of composite arbitration scores; or weighted historical averaging of scores. Such controls prevent rapid toggling between streams and maintain narrative continuity.

Candidate video streams do not autonomously trigger selection or transitions. Selection authority resides exclusively within system 100 (FIG. 1), and competitive arbitration is performed centrally.

This structural separation ensures that selection logic is governed by composite arbitration rather than by per-stream event triggers.

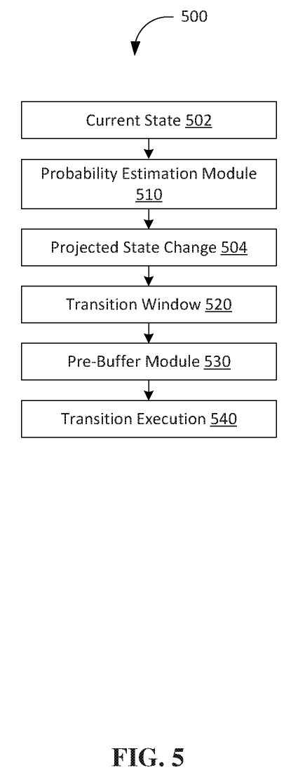

Referring to FIG. 5, a predictive transition window determination mechanism 500 is illustrated. In addition to computing composite arbitration scores, the system may determine a predicted transition window 520 based on a projected change in the temporal narrative state.

The predictive mechanism utilizes: current narrative state 502 (as determined in FIG. 2); and projected future state 504 (i.e., projected state change).

A probability estimation module 510 evaluates the likelihood of transition from the current narrative state 502 to a subsequent state within a future time interval. Projection may be based on: rate of change of contextual indicators; acceleration of motion intensity; increasing subject convergence; event progression indicators; or other temporal patterns derived from contextual features.

The probability estimation module 510 may compute: threshold-based transition likelihood; probabilistic transition metrics; sliding window trend analysis; or rule-based phase change detection.

When the probability of a narrative state change exceeds a predefined condition, the system determines a predicted transition window 520. The predicted transition window represents a time interval during which a transition between streams is considered contextually appropriate.

The transition window may be: a forward-looking time interval; a dynamic time band defined relative to projected peak occurrence; or an interval centered around the expected narrative phase transition.

The predicted transition window 520 does not itself select a stream. Rather, it constrains or influences when a transition may occur.

In some embodiments, upon identification of predicted transition window 520, a pre-buffer module 530 prepares candidate stream data for a potential transition.

Pre-buffering may include: pre-fetching frames; pre-decoding video segments; aligning frame timing; stabilizing candidate stream feed; or preparing transition effects. Pre-buffering ensures a smooth transition when selection is executed.

Transition execution module 540 performs the transition within the predicted transition window. Thus, transition timing is not purely reactive to instantaneous score superiority. Instead, transition is aligned with projected narrative progression.

Predictive transition window determination operates as a temporal gating mechanism. Composite arbitration determines which stream is preferred. Predictive transition window determines when the transition is appropriate.

In some embodiments, predictive transition window determination may be omitted; transitions may be reactive only; the predictive window may be used only during specific narrative states (e.g., escalation to peak). The disclosure is not limited to predictive transition control in all embodiments.

The system 100 may operate in real-time during capture of a real-world occurrence, in post-capture mode after recording has completed, or in a hybrid mode combining both operational characteristics. The mode of operation influences interaction between contextual feature derivation, temporal narrative state determination, marginal contribution computation, redundancy suppression, composite arbitration, and transition control.

In real-time embodiments, candidate video streams are processed as streaming inputs. Contextual indicators are derived continuously or at defined processing intervals. Feature derivation may rely on sliding time windows, such that contextual indicators reflect recent activity rather than complete event knowledge.

Temporal narrative state determination (FIG. 2) in real-time mode operates incrementally. Transition logic may depend on detection of threshold crossings, acceleration of contextual change, or trend estimation over short time horizons. Because future frames are not yet available, projection of state transitions (FIG. 5) may rely on extrapolation of recent contextual trends.

Marginal contribution computation (FIG. 3) is performed relative to the currently selected output stream using contextual divergence derived from recent frames. Redundancy suppression operates simultaneously to prevent switching to streams that replicate current contextual content.

Composite arbitration scores (FIG. 4) are recalculated at defined intervals, and competitive selection (FIG. 6) may require persistence or margin superiority before a transition is executed. Transition timing may be constrained by latency requirements, and predictive transition windows may be relatively short.

Consider multiple cameras capturing a race event. During a gradual acceleration period, contextual indicators show increasing motion magnitude and subject convergence. The narrative state transitions from build-up to escalation. Marginal contribution computation identifies that an alternate viewpoint provides greater divergence relative to the currently selected stream. However, redundancy suppression may prevent immediate switching if contextual overlap remains high. When projected contextual acceleration indicates an imminent peak event, the predictive transition window mechanism enables transition at a moment aligned with the anticipated peak, subject to composite arbitration score comparison.

In another example, considering a live discussion event, multiple cameras capture different participants. During a stable conversational period, contextual indicators remain low in motion intensity. The system maintains a selected stream until divergence is detected, such as a participant beginning a gesture or speaking. Redundancy suppression prevents switching between similar framing views. Marginal contribution increases when a camera provides clearer framing of the active speaker. Competitive arbitration triggers a transition while maintaining minimum display duration constraints to avoid oscillation.

In post-capture embodiments, the system processes recorded candidate streams with access to complete event timelines. Contextual indicators may be derived across extended time windows, enabling more stable and comprehensive narrative modelling.

Temporal narrative state determination may incorporate forward and backward analysis. For example, identification of a peak phase may rely on detection of maximum contextual intensity across the full duration rather than short-term estimation. State transitions may therefore be more precisely aligned with actual event progression.

Marginal contribution values may be computed for segments rather than frame-by-frame intervals. Redundancy suppression may evaluate duplication across longer durations, identifying repeated viewpoint sequences and suppressing repetitive segments in the directed output.

Composite arbitration may incorporate smoothing or optimization across multiple adjacent segments. Transition timing may be selected based on broader contextual continuity rather than immediate responsiveness.

In a recorded multi-camera track event, the system analyzes complete race footage. A peak segment is identified where multiple participants converge at a turn. The system evaluates contextual divergence across candidate streams for that segment and selects a stream providing maximal incremental contextual information relative to preceding segments. Redundant streams capturing substantially identical framing are suppressed across the segment duration. Transition timing is selected to coincide precisely with the identified peak entry.

In a recorded training session captured by several fixed cameras, the system analyzes long intervals of repetitive drills. Redundancy suppression identifies segments where camera views remain contextually similar for extended periods. During a moment of increased activity, the narrative state transitions from build-up to escalation. The system selects a candidate stream offering distinct subject positioning and higher contextual divergence relative to the preceding output sequence. Because full timeline data is available, transitions may be aligned with true activity onset rather than estimated trends.

In hybrid embodiments, the system performs initial real-time arbitration to generate a live directed output stream and subsequently performs post-capture refinement.

During refinement, the system may: recompute narrative state using complete contextual information; adjust transition timing identified during real-time operation; replace segments where alternative candidate streams exhibit higher marginal contribution; reduce long-term redundancy across the full output sequence.

Hybrid mode allows preservation of real-time responsiveness while enabling retrospective enhancement of narrative continuity and contextual differentiation.

The system is not limited to any particular operational mode. Window sizes, recomputation intervals, transition thresholds, and projection horizons may be adjusted based on computational resources, latency constraints, or desired editorial behavior.

In all operational modes, arbitration logic remains governed by: relative contextual divergence, redundancy suppression, composite arbitration score generation, and competitive selection.

The system 100 is capable of operating with a variable number of candidate video streams and may dynamically adapt to changes in stream availability during operation.

In certain embodiments, additional candidate video streams may become available during operation. Upon receipt of a new candidate stream, contextual feature derivation is initiated for the new stream; a contextual feature representation is generated; marginal contribution value is computed relative to the currently selected output stream; redundancy penalty is computed; and composite arbitration score is generated. The new candidate stream may immediately participate in competitive arbitration without requiring a restart of system operation.

During a live event, an additional mobile device begins streaming a new viewpoint. The system derives contextual indicators for the new stream and computes its marginal contribution relative to the current output. If the new stream provides substantial incremental contextual divergence and is not redundant, its composite arbitration score may exceed that of the current stream, resulting in selection during an appropriate transition window.

In some embodiments, one or more candidate streams may become unavailable due to network interruption, device failure, or voluntary termination.

Upon removal of a candidate stream: contextual feature representations associated with the removed stream are invalidated; the composite arbitration score for that stream is withdrawn; arbitration continues among remaining candidate streams. If the currently selected output stream becomes unavailable, transition control module 150 may immediately trigger competitive selection among remaining candidate streams.

If a selected stream experiences a loss of signal during the escalation state, the system recomputes arbitration using the remaining candidate streams. Marginal contribution and redundancy penalties are recalculated relative to the most recent valid output context, and a replacement stream is selected based on composite arbitration score and transition constraints.

The arbitration architecture does not require a fixed number of candidate streams. The system may operate with: two candidate streams; dozens of candidate streams; or dynamically varying numbers of streams.

Marginal contribution computation and redundancy suppression scale proportionally with the number of candidate streams. Composite arbitration engine performs a competitive comparison across all active streams.

In high-volume embodiments, computational optimization techniques may be used, such as prioritizing streams with high preliminary contextual divergence, limiting redundancy comparison to top-N candidate streams, and hierarchical arbitration stages. Such optimizations do not alter the core arbitration logic.

Although arbitration logic is a centralized concept within system 100, computational components may be distributed across multiple processing units. For example, contextual feature derivation may occur at edge nodes associated with capture devices; marginal contribution and redundancy computations may occur at an intermediate processing layer; composite arbitration and transition control may occur at a central coordination unit.

In such embodiments, intermediate contextual feature representations may be transmitted instead of full-resolution video data to reduce bandwidth. However, arbitration decisions remain governed by composite arbitration logic and not by autonomous per-stream control.

In embodiments involving a large number of independent capture devices, the system may: group candidate streams based on contextual similarity; perform preliminary clustering; perform arbitration within clusters before global arbitration.

For example, streams capturing similar spatial regions may be clustered, and a representative stream selected within each cluster prior to final composite arbitration. This hierarchical approach enables scalability while preserving marginal contribution and redundancy suppression principles.

The system may allocate computational resources dynamically based on the narrative state. For example, during build-up state, lower arbitration frequency may be sufficient; during escalation or peak states, arbitration loop frequency may increase; predictive transition window computation may be prioritized during projected phase transitions. Such adaptive allocation improves computational efficiency without altering the arbitration structure.

Candidate video streams may be asynchronous with respect to one another. The system may: align streams using timestamps when available; apply approximate synchronization windows; evaluate contextual divergence and similarity based on temporally aligned segments.

Asynchronous capture does not prevent inter-stream arbitration, provided contextual comparison is performed within consistent temporal reference frames.

In embodiments involving a large number of independent capture devices, the system may: group candidate streams based on contextual similarity; perform preliminary clustering; perform arbitration within clusters before global arbitration.

For example, streams capturing similar spatial regions may be clustered, and a representative stream selected within each cluster prior to final composite arbitration.

This hierarchical approach enables scalability while preserving marginal contribution and redundancy suppression principles.

The system may allocate computational resources dynamically based on narrative state. For example, during build-up state, lower arbitration frequency may be sufficient; during escalation or peak states, arbitration loop frequency may increase; predictive transition window computation may be prioritized during projected phase transitions. Such adaptive allocation improves computational efficiency without altering the arbitration structure.

Candidate video streams may be asynchronous with respect to one another. The system may: align streams using timestamps when available; apply approximate synchronization windows; evaluate contextual divergence and similarity based on temporally aligned segments. Asynchronous capture does not prevent inter-stream arbitration, provided contextual comparison is performed within consistent temporal reference frames.

In some embodiments, composite arbitration may be implemented using deterministic rule sets. In other embodiments, arbitration may utilize probabilistic or optimization-based models.

In deterministic embodiments, marginal contribution value may be computed using explicit divergence thresholds; redundancy penalty may be applied when similarity exceeds fixed bounds; selection may occur when composite arbitration score exceeds a fixed switching margin. Such embodiments enable predictable behavior suitable for constrained environments.

In alternative embodiments, the composite arbitration score may represent a probability of stream suitability. For example, marginal contribution value may be normalized into a probabilistic relevance score; redundancy penalty may reduce the probability of selection; final selection may be performed via probabilistic sampling weighted by composite arbitration score.

Such embodiments may reduce abrupt transitions and introduce controlled variability.

In post-capture embodiments, arbitration may be formulated as an optimization problem across a sequence of time intervals.

For example, the system may determine a sequence S of stream selections over time horizon T such that: total marginal contribution across T is maximized; total redundancy across T is minimized; the number of transitions is bounded. This may be implemented using dynamic programming, constrained optimization, or sequence modelling techniques.

To prevent oscillatory switching between streams, the system may incorporate stability mechanisms.

A candidate stream may be required to exceed the currently selected stream’s composite arbitration score by a margin δ for a duration τ before transition is executed.

Composite arbitration scores may be smoothed using: exponential moving averages, weighted rolling averages, and decay-based memory of previous scores.

Each selected stream may be required to remain active for a minimum duration unless overridden by extreme contextual divergence.

In certain embodiments, the system maintains historical context data beyond immediate frames.

A context history buffer may store: past narrative states; past composite arbitration scores; recent transition timestamps. This buffer may influence current arbitration decisions.

Redundancy suppression may consider repetition over extended durations. For example: repeated use of similar framing within a rolling time window; repeated alternation between two nearly identical viewpoints. Such detection prevents cyclical redundancy patterns.

In high-density capture environments, arbitration may occur in multiple stages. Candidate streams with marginal contributions below a minimum threshold may be filtered before redundancy comparison. Candidate streams may be grouped into similarity clusters, and representative streams selected from each cluster prior to global arbitration. Composite arbitration may then be applied across cluster representatives.

If multiple candidate streams exhibit high marginal contribution simultaneously, selection may be governed by: temporal weighting preference; stability priority; previous output continuity.

If all candidate streams exhibit high contextual similarity, the system may: maintain the current stream; select the stream with a superior composition indicator; defer switching until divergence increases.

If the narrative state transition probability remains below the confidence threshold, the system may: maintain prior narrative state; apply conservative arbitration thresholds; increase smoothing window length.

Arbitration sensitivity may vary dynamically. For example, during escalation or peak states, the switching threshold may be lowered; during resolution, the switching threshold may be raised; during stable periods, redundancy penalty scaling may increase. Such adaptive behavior enhances narrative continuity.

In certain embodiments, arbitration parameters may be influenced by viewer interaction signals. For example, user preference for wide-angle views may adjust weighting; preference for dynamic transitions may reduce hysteresis margin. However, the arbitration structure remains based on marginal contribution and redundancy suppression.

In distributed embodiments, contextual feature representations may be authenticated; timestamp validation may ensure temporal alignment; corrupted streams may be excluded from arbitration.

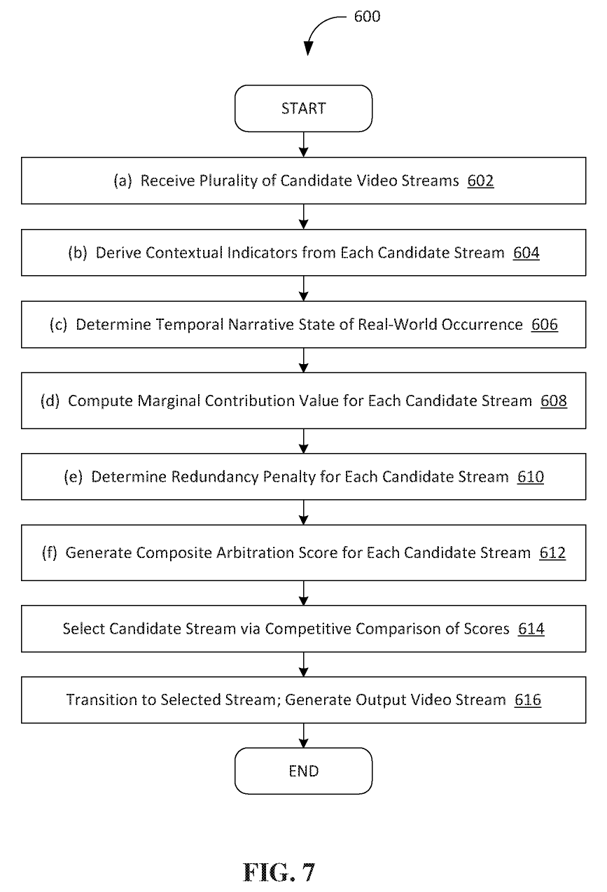

FIG. 7 illustrates a flowchart of a method 600 for automated arbitration between multiple simultaneous video streams capturing a common real-world occurrence, in accordance with some embodiments. Further, the method 600 may include a step 602 of receiving a plurality of candidate video streams. Further, the method 600 may include a step 604 of deriving contextual indicators from each candidate stream. Further, the method 600 may include a step 606 of determining the temporal narrative state of a real-world occurrence. Further, the method 600 may include a step 608 of computing the marginal contribution value for each candidate stream. Further, the method 600 may include a step 610 of determining a redundancy penalty for each candidate stream. Further, the method 600 may include a step 612 of generating a composite arbitration score for each candidate stream. Further, the method 600 may include a step 614 of selecting a candidate stream via competitive comparison of scores. Further, the method 600 may include a step 616 of transitioning to a selected stream and generating an output video stream.

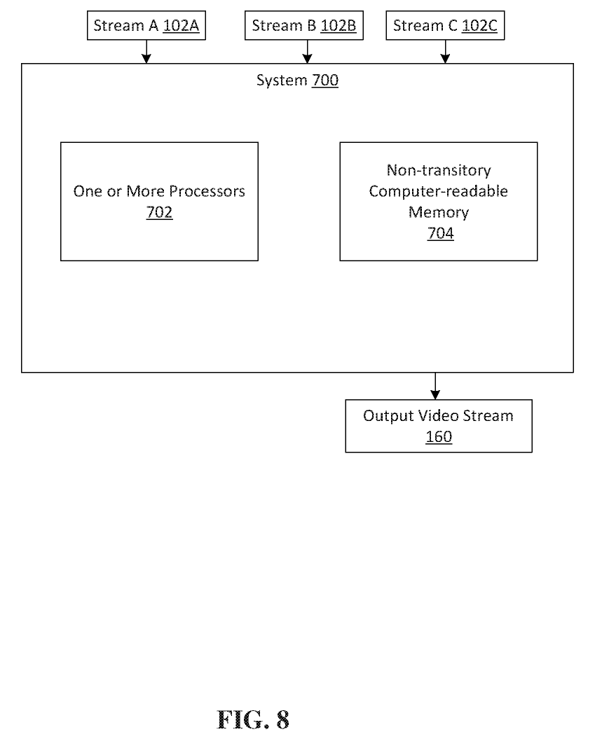

FIG. 8 illustrates a block diagram of a system 700 for automated selection of a video stream from a plurality of simultaneous video streams capturing a common real-world occurrence, in accordance with some embodiments. Accordingly, the system 700 may include one or more processors 702 and a non-transitory computer-readable memory 704. Further, the non-transitory computer-readable memory 704 stores instructions that, when executed by the one or more processors 702, cause the system 700 to receive a plurality of candidate video streams corresponding to different viewpoints of the common real-world occurrence. Further, the non-transitory computer-readable memory 704 stores instructions that, when executed by the one or more processors 702, cause the system 700 to determine, based on at least one of a visual feature, an activity indicator, and an event progression indicator derived from the plurality of candidate video streams, a temporal narrative state of the common real-world occurrence. Further, the non-transitory computer-readable memory 704 stores instructions that, when executed by the one or more processors 702, cause the system 700 to for each candidate video stream of the plurality of candidate video streams, compute a marginal contribution value relative to a currently selected output video stream, the marginal contribution value representing an incremental contextual relevance of each candidate video stream with respect to the temporal narrative state. Further, the non-transitory computer-readable memory 704 stores instructions that, when executed by the one or more processors 702, cause the system 700 to determine a redundancy penalty for at least one candidate video stream of the plurality of candidate video streams based on contextual overlap with the currently selected output video stream. Further, the non-transitory computer-readable memory 704 stores instructions that, when executed by the one or more processors 702, cause the system 700 to generate a composite arbitration score for each candidate video stream based on at least one of the marginal contribution value and the redundancy penalty. Further, the non-transitory computer-readable memory 704 stores instructions that, when executed by the one or more processors 702, cause the system 700 to select a candidate video stream of the plurality of candidate video streams for output based on the composite arbitration score and generate an output video stream by transitioning from the currently selected output video stream to the candidate video stream.

The systems and methods described herein provide a structured inter-stream arbitration architecture based on temporal narrative modeling, incremental contextual divergence, and redundancy suppression.

Unlike independent ranking systems, the present disclosure performs relative contextual evaluation between candidate streams and a currently selected output stream, integrates narrative-phase awareness into arbitration logic, and separates stream selection from transition timing through predictive transition window determination.

The modular architecture enables operation across real-time, post-capture, and hybrid environments; scales across variable numbers of candidate streams; and supports deterministic, probabilistic, and optimization-based arbitration variants without altering the underlying inter-stream comparative framework.

In some embodiments, a technical problem in multi-camera video production may include redundant viewpoint selection that wastes compute cycle and bitrate while degrading viewer-perceived continuity, and a technical feature that may improve automated video production technology may include computing, for each candidate video stream, a marginal contribution value relative to a currently selected output stream such that selection may be driven by incremental contextual information rather than by an isolated per-stream quality score. In some embodiments, the marginal contribution value may be implemented by deriving a contextual feature representation for a candidate video stream and for the currently selected output stream, and then computing a contextual divergence measure that may quantify the difference in at least one of motion characteristic, subject position, framing characteristic, scene coverage, or event progression indicator. In some embodiments, the contextual divergence measure may be implemented using a distance metric between feature vectors, a cosine dissimilarity between embeddings, a weighted feature delta, or a thresholded deviation rule that may emphasize one feature dimension when another feature dimension is saturated. In some embodiments, an example implementation may include computing optical flow magnitude statistic over a sliding time window for each stream, computing a subject bounding region trajectory for each stream, and then producing a divergence score that may increase when the candidate stream shows a different subject region or a different motion pattern than the currently selected output stream, thereby improving multi-stream selection technology by reducing viewpoint repetition while preserving salient event coverage.

In some embodiments, a technical problem in conventional stream arbitration may include contextually duplicative switching in which two streams with similar framing alternately win a score race due to minor metric fluctuation, and a technical feature that may improve stream arbitration technology may include determining a redundancy penalty when contextual similarity between the candidate video stream and the currently selected output stream exceeds a similarity threshold, thereby suppressing selection of contextually redundant viewpoint before final arbitration. In some embodiments, contextual similarity may be implemented using an overlap coefficient on region-of-interest coverage, structural similarity on downsampled frame descriptor, similarity of motion vector histogram, similarity of subject position distribution, or similarity of viewpoint orientation indicator derived from camera motion estimate. In some embodiments, the redundancy penalty may be implemented as a piecewise function in which a first tier may apply no suppression below a first similarity threshold, a second tier may apply increasing suppression above the first similarity threshold, and a third tier may apply near-hard suppression above a second similarity threshold. In some embodiments, an example implementation may include computing a subject region overlap ratio between streams and applying a penalty that may increase as the overlap ratio approaches unity, thereby improving automated video editing technology by reducing oscillatory switching and reducing redundant output segments.

In some embodiments, a technical problem in automated switching may include reactive decisions that fragment narrative continuity because an instantaneous metric peak may trigger a premature cut, and a technical feature that may improve narrative-aware video production technology may include determining a temporal narrative state of a real-world occurrence and dynamically modulating arbitration behavior using the temporal narrative state. In some embodiments, the temporal narrative state may be implemented as a state variable representing an event phase, and the event phase may include a build-up state, an escalation state, a peak state, or a resolution state, and transitions may be governed by threshold logic, rule logic, a state transition matrix, or probabilistic transition. In some embodiments, the contextual indicator used to update the temporal narrative state may include rate of change of motion intensity, the acceleration of subject movement, convergence of subject region, entry or exit of a subject region, or detection of repeated action cycle, and each contextual indicator may be computed per frame and aggregated over a time window to reduce noise. In some embodiments, an example implementation may include increasing weight on motion divergence during the escalation state and increasing weight on composition stability during the resolution state, thereby improving automated camera switching technology by aligning selection behavior with event progression rather than with a single instantaneous score.

In some embodiments, a technical problem in multi-feature decisioning may include unstable selection when independent heuristics disagree, and a technical feature that may improve arbitration engine technology may include generating a composite arbitration score for each candidate video stream using at least the marginal contribution value and the redundancy penalty, and optionally using a temporal weighting factor that may depend on the temporal narrative state. In some embodiments, the composite arbitration score may be implemented using additive formulation, multiplicative formulation, weighted sum formulation, or rule-based formulation, and the formulation may be configured to reduce sensitivity to transient spikes by applying smoothing, hysteresis, or score persistence constraint. In some embodiments, an example implementation may include computing a base contextual relevance component as the marginal contribution value, subtracting the redundancy penalty, and adding a temporal weight that may favor stable framing during the build-up state, thereby improving automated selection technology by producing a score that is explicitly relative to the currently selected output stream and is less prone to redundant switching.

In some embodiments, a technical problem in live production may include transition timing that is either too early or too late due to latency and limited lookahead, and a technical feature that may improve transition control technology may include determining a predicted transition window based on a projected change in the temporal narrative state and using the predicted transition window as a temporal gating signal for switching. In some embodiments, projection may be implemented using trend estimation over contextual indicator time series, rate-of-change analysis of event progression indicator, or thresholded likelihood estimation of state transition within a future interval. In some embodiments, the predicted transition window may be defined as a forward-looking interval anchored to an estimated time of peak event, and the interval width may be adjusted based on the confidence of the projection. In some embodiments, an example implementation may include detecting rising motion intensity slope and increasing subject convergence that may indicate an imminent peak, and then allowing a cut only within a window centered on the anticipated peak, thereby improving live video switching technology by aligning cut timing with event dynamics.

In some embodiments, a technical problem in stream switching may include a visible glitch and decode stall when a newly selected stream is not prepared for immediate output, and a technical feature that may improve streaming pipeline technology may include pre-buffering candidate stream data during the predicted transition window. In some embodiments, pre-buffering may include pre-fetching frame, pre-decoding segment, aligning timestamp, stabilizing candidate feed, or preparing transition effect parameter so that transition may occur without output underrun. In some embodiments, pre-buffering may be implemented by selecting a segment of the candidate stream that corresponds to the predicted transition window, decoding the segment into an intermediate representation, and storing the intermediate representation in a buffer that may be retrieved at transition time. In some embodiments, an example implementation may include maintaining a rolling decode buffer for a top-ranked candidate stream while maintaining a smaller metadata-only buffer for other stream, thereby improving network video delivery technology by reducing decode latency and reducing transition artifact.

In some embodiments, a technical problem in heterogeneous multi-camera capture may include unfair comparison across stream due to differing resolution, frame rate, exposure, or latency, and a technical feature that may improve cross-stream comparability technology may include normalizing contextual indicator so that divergence and similarity computation may be computed on a common scale. In some embodiments, normalization may include per-feature z-score normalization, per-stream calibration using baseline window, quantization into comparable bin, or scaling by frame rate to compare motion indicator across differing sampling. In some embodiments, an example implementation may include normalizing optical flow magnitude by frame interval and normalizing brightness statistic by exposure estimate, thereby improving multi-stream analysis technology by reducing selection bias caused by capture setting rather than by scene content.

In some embodiments, a technical problem in asynchronous capture may include misaligned content comparison that yields incorrect redundancy suppression, and a technical feature that may improve asynchronous stream arbitration technology may include aligning streams using timestamp when available or applying an approximate synchronization window when timestamp is absent. In some embodiments, alignment may be implemented by selecting temporally corresponding segment based on nearest timestamp match, by estimating lag via feature correlation between streams, or by using a sliding alignment search that maximizes similarity of event progression indicator. In some embodiments, an example implementation may include correlating motion intensity curve between two stream to estimate an offset and then computing divergence on offset-corrected window, thereby improving inter-stream comparison technology by ensuring that similarity and divergence represent actual scene difference rather than timing skew.

In some embodiments, a technical problem in high-volume capture may include computational scaling that grows with stream count and may exceed real-time budget, and a technical feature that may improve scalability of arbitration technology may include filtering stream with marginal contribution below a minimum threshold prior to redundancy comparison, clustering stream by contextual similarity, or performing hierarchical arbitration that selects a representative stream per cluster before global comparison. In some embodiments, clustering may be implemented by grouping streams with similar contextual feature representation and selecting a cluster representative with highest marginal contribution, and then computing final composite arbitration score only for representative. In some embodiments, an example implementation may include limiting similarity comparison to a top-N candidate stream chosen by preliminary divergence, thereby improving compute efficiency technology while preserving the relative-evaluation principle of the arbitration.

In some embodiments, a technical problem in distributed deployment may include bandwidth overhead of shipping full video to a central service, and a technical feature that may improve bandwidth efficiency technology may include deriving contextual feature representation at an edge node and transmitting the contextual feature representation rather than full-resolution video for arbitration decision. In some embodiments, feature derivation may be executed on a device that is part of the service infrastructure and may transmit feature vector, indicator time series, or compressed descriptor to a coordinating processing tier that may compute marginal contribution and redundancy penalty. In some embodiments, an example implementation may include extracting subject bounding region and motion histogram at an edge compute instance close to ingestion point and transmitting only these feature to the arbitration engine, thereby improving network resource technology by reducing upstream bandwidth while maintaining accurate inter-stream comparison.

In some embodiments, a technical problem in contextual feature design may include brittleness of hand-crafted indicator across diverse event type, and an additional technical feature that may improve video understanding technology may include generating a learned video embedding for the candidate video stream data and for the currently selected output stream data and computing contextual divergence and contextual similarity using the learned video embedding. In some embodiments, the learned video embedding may be produced by a neural encoder that may operate on a short clip, on sparse frame sample, or on a motion-compensated representation, and the encoder may output a fixed-length vector that may be compared using cosine distance. In some embodiments, an example implementation may include producing an embedding for a five-second window and combining the embedding distance with a subject-region overlap signal so that the system may penalize redundancy even when raw pixel difference is noisy, thereby improving video feature extraction technology and strengthening a technical improvement argument for eligibility by tying selection to a specific non-generic video signal processing pipeline.

In some embodiments, a technical problem in live SaaS arbitration may include latency constraint that conflicts with repeated recomputation, and an additional technical feature that may improve low-latency streaming technology may include scheduling arbitration recomputation frequency based on the temporal narrative state such that arbitration loop may run at lower frequency during build-up state and may run at higher frequency during escalation state or peak state. In some embodiments, scheduling may be implemented by adjusting window length for contextual indicator aggregation, adjusting sampling interval for motion indicator, or adjusting number of candidate stream evaluated per cycle. In some embodiments, an example implementation may include running full similarity computation only when a transition likelihood exceeds a threshold and otherwise running a lightweight divergence-only pass, thereby improving compute utilization technology and reducing tail latency.

In some embodiments, a technical problem in switching stability may include rapid toggling when two candidate stream have near-equal composite arbitration score, and an additional technical feature that may improve control stability technology may include applying hysteresis and temporal smoothing to the composite arbitration score via an exponential moving average and enforcing a minimum hold time for the currently selected output stream. In some embodiments, smoothing may be implemented by maintaining a score history buffer and updating a smoothed score with a decay factor, and hold time may be implemented by a timer that may block switching until a minimum duration elapses unless an override condition is satisfied. In some embodiments, an example implementation may include requiring the candidate stream to exceed the current stream by a margin for a persistence duration before switching, thereby improving stability of the switching controller and reducing oscillation artifact.

In some embodiments, a technical problem in fairness and drift may include long-term bias toward a stream with consistently higher intrinsic quality metric even when it is contextually redundant, and an additional technical feature that may improve multi-camera selection fairness technology may include adapting redundancy threshold or redundancy penalty scaling based on an output duration of the currently selected output stream. In some embodiments, adaptation may be implemented by decreasing similarity tolerance as continuous output duration increases, or by increasing redundancy penalty when the same viewpoint has persisted beyond a duration threshold, thereby encouraging viewpoint diversity without requiring any user input. In some embodiments, an example implementation may include raising the redundancy penalty slope after thirty seconds of continuous selection, thereby improving diversity control technology while maintaining narrative continuity.

In some embodiments, a technical problem in packet loss and variable network path may include inconsistent availability of candidate stream that destabilizes arbitration, and an additional technical feature that may improve fault tolerance technology may include maintaining a stream availability state and excluding a stream from competitive comparison when a signal integrity indicator falls below a threshold. In some embodiments, the signal integrity indicator may include missing frame rate, jitter metric, decode error rate, or buffer underflow event count, and exclusion may be implemented by setting a composite arbitration score floor or by marking the stream inactive for a cooldown interval. In some embodiments, an example implementation may include falling back to a next-highest composite arbitration score stream when the currently selected stream becomes unavailable and immediately reseeding contextual feature representation for the new selection, thereby improving reliability technology for SaaS live production.

In some embodiments, a technical problem in compute cost for similarity evaluation may include quadratic growth when comparing many stream, and an additional technical feature that may improve approximate similarity search technology may include indexing contextual feature representation in a vector index and retrieving only a nearest-neighbor subset for redundancy evaluation relative to the currently selected output stream. In some embodiments, the vector index may be updated periodically with the most recent feature vector per stream, and retrieval may yield a small candidate set whose similarity may be computed with higher-fidelity metric. In some embodiments, an example implementation may include using an approximate nearest-neighbor search over embedding to find the most redundant stream and then applying redundancy penalty only to that subset, thereby improving computational scalability technology while maintaining redundancy suppression behavior.

In some embodiments, a technical problem in post-capture optimization may include locally optimal switching that yields globally repetitive output over a long timeline, and an additional technical feature that may improve sequence optimization technology may include optimizing a sequence of stream selection over a time horizon subject to an objective that may maximize total marginal contribution while minimizing total redundancy and bounding a number of transition. In some embodiments, optimization may be implemented using dynamic programming over segment boundary, constrained shortest path over a graph of segment-to-stream assignment, or beam search over candidate sequence with a transition penalty. In some embodiments, an example implementation may include segmenting an event into fixed-length interval, computing composite arbitration score per interval per stream, and then selecting a path that penalizes repeated viewpoint across adjacent interval, thereby improving post-production editing technology by producing a more coherent directed output stream than a purely greedy per-interval selection.

The embodiments described herein are illustrative and not restrictive. Modifications, variations, and equivalent arrangements are within the scope of the appended claims.

What is claimed is:

1. A system for automated selection of a video stream from a plurality of simultaneous video streams capturing a common real-world occurrence, the system comprising:
one or more processors; and
a non-transitory computer-readable memory storing instructions that, when executed by the one or more processors, cause the system to:
(a) receive a plurality of candidate video streams corresponding to different viewpoints of the common real-world occurrence;
(b) determine, based on at least one of a visual feature, an activity indicator, and an event progression indicator derived from the plurality of candidate video streams, a temporal narrative state of the common real-world occurrence;
(c) for each candidate video stream of the plurality of candidate video streams, compute a marginal contribution value relative to a currently selected output video stream, the marginal contribution value representing an incremental contextual relevance of each candidate video stream with respect to the temporal narrative state;
(d) determine a redundancy penalty for at least one candidate video stream of the plurality of candidate video streams based on contextual overlap with the currently selected output video stream;
(e) generate a composite arbitration score for each candidate video stream based on at least one of the marginal contribution value and the redundancy penalty; and
(f) select a candidate video stream of the plurality of candidate video streams for output based on the composite arbitration score and generate an output video stream by transitioning from the currently selected output video stream to the candidate video stream.

2. The system of claim 1, wherein the determining of the temporal narrative state comprises classifying the common real-world occurrence into one of a plurality of event phases comprising at least two of a build-up phase, an escalation phase, a peak phase, and a resolution phase.

3. The system of claim 1, wherein the determining of the temporal narrative state comprises maintaining a state variable that transitions between predefined event phases according to a detected contextual trigger derived from at least one of a threshold crossing of a contextual indicator, a rate-of-change of a contextual indicator, or a detected transition in event progression indicators derived from the plurality of candidate video streams.

4. The system of claim 3, wherein transition between the predefined event phases is governed by a state transition matrix.

5. The system of claim 1, wherein the temporal narrative state is determined independently of any single candidate video stream of the plurality of candidate video streams and is derived from aggregated contextual indicators across multiple candidate video streams of the plurality of candidate video streams.

6. The system of claim 1, wherein the marginal contribution value is computed as a function of a contextual divergence between each candidate video stream of the plurality of candidate video streams and the currently selected output video stream.

7. The system of claim 6, wherein the contextual divergence comprises at least one of:
° a difference in subject position,
° a difference in motion vector,
° a difference in focal region, and
° a difference in detected action intensity.

8. The system of claim 1, wherein the marginal contribution value decreases when a contextual similarity between each candidate video stream and the currently selected output video stream exceeds a predefined threshold.

9. The system of claim 1, wherein the redundancy penalty is dynamically adjusted based on a duration of continuous output of the currently selected output video stream.

10. The system of claim 1, wherein the redundancy penalty suppresses the at least one candidate video stream that does not materially alter a narrative perspective from being selected as the candidate video stream.

11. The system of claim 1, wherein the generating of the composite arbitration score further comprises applying a temporal weighting factor to at least one of the marginal contribution value or the redundancy penalty, wherein the temporal weighting factor is associated with the temporal narrative state.

12. The system of claim 1, wherein the non-transitory computer-readable memory further comprises instructions that, when executed by the one or more processors, cause the system to determine a predicted transition window representing a time interval during which transition from the currently selected output video stream to the selected candidate video stream is determined to be contextually appropriate, corresponding to a projected change in the temporal narrative state.

13. The system of claim 12, wherein the determining of the predicted transition window comprises estimating a probability of occurrence of a forthcoming event phase transition, wherein the probability is estimated based on contextual indicators derived from the plurality of candidate video streams and corresponds to a forthcoming transition of the temporal narrative state to a subsequent predefined event phase.

14. The system of claim 12, wherein video data corresponding to at least one candidate video stream is pre-buffered prior to execution of the transition from the currently selected output video stream to the selected candidate video stream within the predicted transition window.

15. The system of claim 1, wherein the selection of the candidate video stream is performed through competitive comparison of composite arbitration scores of the plurality of candidate video streams against the composite arbitration score of the currently selected output video stream, wherein the composite arbitration scores of the plurality of candidate video streams is used rather than independent ranking of the plurality of candidate video streams.

16. The system of claim 1, wherein the composite arbitration score comprises:
° Composite Arbitration Score = (Marginal Contribution Value) − (Redundancy Penalty) + (Temporal Weighting Factor),
° wherein the Marginal Contribution Value represents incremental contextual relevance of each candidate video stream relative to the currently selected output video stream, and
° wherein the Redundancy Penalty represents a suppression factor based on contextual similarity between each candidate video stream and the currently selected output video stream, and the Temporal Weighting Factor is determined based on the temporal narrative state.

17. The system of claim 1, wherein the plurality of candidate video streams comprises video streams captured by distinct user-operated devices operating independently of editorial control.

18. The system of claim 1, wherein the marginal contribution value is dynamically updated during the generation of the output video stream.

19. A method for automated arbitration between multiple simultaneous video streams capturing a common real-world occurrence, the method comprising:
(a) receiving a plurality of candidate video streams;
(b) determining a temporal narrative state of the common real-world occurrence based on contextual indicators derived by analyzing at least one of a visual feature, an activity indicator, and an event progression indicator of each of the plurality of candidate video streams, derived from the plurality of candidate video streams;
(c) computing, for each candidate video stream of the plurality of candidate video streams, a marginal contribution value relative to a currently selected output video stream;
(d) determining a redundancy penalty associated with contextual similarity between each candidate video stream of the plurality of candidate video streams and the currently selected output video stream;
(e) generating a composite arbitration score for each candidate video stream of the plurality of candidate video streams based on at least the marginal contribution value and the redundancy penalty; and
(f) selecting a candidate video stream of the plurality of candidate video streams for output based on the composite arbitration score and transitioning to the selected candidate video stream.

20. The method of claim 19, wherein the determining of the temporal narrative state comprises classifying the common real-world occurrence into one of a plurality of predefined event phases.

21. The method of claim 19, wherein the computing of the marginal contribution value comprises determining a contextual divergence between each candidate video stream and the currently selected output video stream.

22. The method of claim 19, wherein the determining of the redundancy penalty comprises identifying contextual similarity exceeding a predefined similarity threshold between each candidate video stream and the currently selected output video stream, wherein the redundancy penalty suppresses at least one candidate video stream that does not materially alter a narrative perspective from being selected as the selected candidate video stream.

23. The method of claim 19, further comprising determining a predicted transition window representing a time interval during which transition from the currently selected output video stream to the selected candidate video stream is determined to be contextually appropriate, based on a projected change in the temporal narrative state.

24. The method of claim 23, further comprising pre-buffering video data of a candidate video stream prior to execution of a transition.

25. The method of claim 19, wherein selecting the candidate video stream comprises competitive comparison of composite arbitration scores of the plurality of candidate video streams against the composite arbitration score of the currently selected output video stream, rather than independent ranking.
